(19) United States
(12) Patent Application Publication
(10) Pub. No.: US 2010/0096315 A1
(43) Pub. Date: Apr. 22, 2010

(54) FLUID FILTER WITH A FILTER ELEMENT WHICH CAN BE INSERTED INTO A FILTER HOUSING

(75) Inventors: Eric Gillenberg, Speyer (DE); Manfred Winter, Oedheim (DE); Klaus Ruhland, Meckenheim (DE); Richard Pawlik, Roemerberg (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/527,813

(22) PCT Filed: Feb. 22, 2008
(86) PCT No.: PCT/EP08/52199

§ 371 Date: Aug. 19, 2009

(30) Foreign Application Priority Data
Feb. 22, 2007 (DE) DE202007002786.9

(51) Int. Cl. B01D 29/00

(52) U.S. Cl. 210/236; 210/232

(57) ABSTRACT

A fluid filter, having a filter element (10) which can be inserted into a filter housing (2), characterized in that the filter element (10) has at least one assembly aid element (12) which is assigned a corresponding housing-side assembly aid element (11) in such a way that the housing-side assembly aid element (11) and the filter-side assembly aid element (12) engage into one another in the installed situation.

### TECHNICAL FIELD

The invention concerns a fluid filter, comprising a filter element insertable into a filter housing, in accordance with the preamble of claim 1.

### PRIOR ART

DE 197 46 752 A1 discloses a liquid filter that is used for filtration of oil or fuel in internal combustion engines. The liquid filter comprises a hollow-cylindrical filter element in a filter housing through which the liquid to be filtered flows radially wherein the outer surface of the filter element forms the unfiltered side and the inner surface forms the filtered side. In order to prevent immediate passage of the liquid to be filtered from the unfiltered side to the filtered side by bypassing the filter element, at the axial end faces a sealing ring is arranged, respectively, that separates flow-tightly the filter element and the housing. The sealing ring is seated in a recess of an axial terminal disk at each end face of the filter element.

During assembly, the filter element, with the housing lid removed, is inserted axially into the housing interior; subsequently, the lid is closed.

### SUMMARY OF THE INVENTION

The invention has the object to configure with simple constructive measures a fluid filter in such a way that incorrect mounting of the components of the fluid filter, in particular of the filter element, is prevented.

This object is solved according to the invention with the features of claim 1. The dependent claims provide expedient further embodiments.

The fluid filter according to the invention, used for filtration of liquids, for example, oil or fuel in internal combustion engines or also for filtration of gases, for example, combustion air in internal combustion engines or breathing air for the vehicle interior, comprises a filter element in a filter housing which filter element is to be flowed through by the fluid. Between the filter element and the inner wall of the housing interior receiving the filter element a sealing element is inserted that separates the unfiltered side from the filtered side of the filter element so that unintended immediate passage from the unfiltered side to the filtered side is prevented. For a proper mounting action, mounting aid elements are provided that are arranged on the filter element or on a secondary filter element and on the housing of the fluid filter, wherein the mounting aid elements at the filter and at the housing are formed in a way so as to match one another so that in the mounted position the mounting aid elements at the filter and at the housing engage one another.

The mounting aid elements ensure the proper mounting position because with their aid a definite positioning in the final mounting position can be ensured. This concerns, on the one hand, the relative angle position of the filter element relative to the housing of the fluid filter; on the other hand, also—cumulatively or alternatively—the axial mounting position of the filter element, and finally, also cumulatively or alternatively, the correct insertion of the filter element with prescribed front side and rear side for preventing a mounting situation accidentally rotated by 180 degrees. The or on corresponding mounting aid elements on the filter element of the inner housing wall ensure that the filter element at least with respect to one of the aforementioned aspects, expediently however with respect to at least two or with respect to all aspects, assumes the correct desired mounting position. When the filter element is accidentally inserted in the wrong way, the mounting aid elements will no longer engage one another and cannot be brought into an engaging position by means of normal mounting forces so that completion of assembly is prevented. This can be recognized by the person carrying out the assembly so that the filter element is brought into its correct position and assembly is completed in the prescribed way.

The mounting aid elements on the housing and on the filter element are embodied expediently as a recess or as a matching projection. The recess is advantageously provided in the filter element and has a bottom so that in case of an accidental insertion of the filter element into the housing with the rear side leading the bottom contacts the correlated projection at the inner side of the housing and a complete axial insertion of the filter element is prevented. This has the result that the side of the filter element that is facing the lid also cannot be completely inserted into the housing so that the lid cannot be mounted in the prescribed way and cannot be closed.

The recess in the filter element and the projection at the inner side of the housing extend in this connection preferably in the axial direction wherein angle deviations relative to the longitudinal axis of the filter element, at the same time representing the insertion direction of the filter element, can be provided also. Such angle deviations are however expediently within a relatively small angle range of, for example, less than 20 degrees. This ensures that by axially inserting the filter element into the housing interior the mounting aid elements, i.e., the projection on the housing and the recess in the filter element, reach an engaging position. Accordingly, automatically the relative angle position of the filter element relative to the housing is secured; moreover, a correct insertion of the filter element with the side provided with the recess is enforced.

In principle, one mounting aid element on the filter element and one on the inner side of the housing, respectively, are sufficient for determining the correct mounting position. In an expedient embodiment, however, several such mounting aid elements are distributed about the circumference. When, for example, two such mounting aid element pairs or even more than two mounting aid element pairs are used, an accidental slanted insertion of the filter element into the housing of the fluid filter can be, at least mostly, prevented at the same time. The filter element is inserted into the housing interior until all mounting aid element pairs engage one another in the prescribed way so that automatically the correct position of the filter element is reached in which the longitudinal plane through the filter element is positioned perpendicularly to the longitudinal filter axis.

The projection in the housing interior that represents the mounting aid element at the housing is advantageously embodied as a socket that is arranged at a radial spacing relative to the inner wall of the housing. Between the inner wall of the housing and the socket an intermediate space is formed that serves for receiving the outer wall of the filter element delimiting the recess. This embodiment can be combined advantageously with a centering wall section that is especially provided immediately at the inner wall of the housing and preferably forms a centering ramp that is positioned at an angle relative to the longitudinal filter axis. Upon axial insertion of the filter element, the radial outer side of the filter element glides along the centering wall section and, in this way, is guided immediately into the intermediate space between the inner wall of the housing and the neighboring wall side of the socket that forms the mounting aid element at the housing. Expediently each socket has correlated therewith precisely one centering wall section.

### BRIEF DESCRIPTION OF THE DRAWINGS

Further advantages and expedient embodiments can be taken from the additional claims, the Figure description and the drawings. It is shown in:

FIG. 1 an illustration of a fluid filter in partial elevation view with a filter element inserted into the housing which filter element is centered by means of mounting aid elements in the housing of the filter;

FIG. 2 a detail view of the inserted filter element in the filter housing with a recess at the sealing side as a mounting aid element into which projects a socket arranged at the housing as a mounting aid element;

FIG. 3 a plan view onto a disk-shaped filter element with diametrically opposed recesses for receiving the sockets provided on the housing;

FIG. 4 a section illustration according to section line IV-IV of FIG. 3 through the filter element;

FIG. 5 a perspective view of the housing interior into which the filter element are to be inserted;

FIG. 6 is an illustration corresponding to FIG. 2 but with the filter element inserted in a wrong position turned by 180 degrees;

FIG. 7 a perspective illustration of a component to be inserted into the housing of the fluid filter which component has in the radial outwardly positioned rim area a recess for receiving a blocking part that prevents wrong insertion of the component into the housing:

FIG. 8 a perspective illustration of the component embodied as a frame which component is to be connected to the filter element, also showing the inserted blocking part;

FIG. 9 a section of the blocking part and the frame;

FIGS. 10 to 13 the blocking part in different views.

In the Figures the same components are identified with same reference numerals.

FIG. 14 a variant of the blocking part illustrated in FIGS. 10 to 13.

FIG. 15 the variant illustrated in FIG. 14 with folded-over blocking segment.

### EMBODIMENT(S) OF THE INVENTION

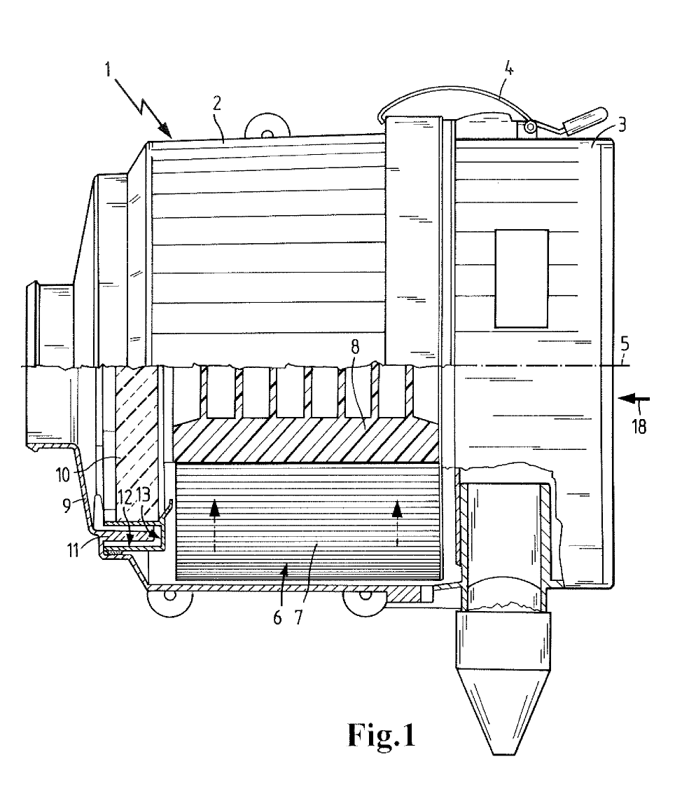

The fluid filter 1 illustrated in FIG. 1 is used for filtration of liquids or gases in motor vehicles, in particular for filtration of the intake air in internal combustion engines. In a filter housing 2 that has a cylindrical or elliptical cross-section, there is a housing interior for receiving a filter element 6 that is embodied as a hollow cylinder and has a filter material 7 wound about a support frame 8. The filter element 6 is flowed through axially by the fluid to be filtered. The filter housing 2 has at one end face a removable housing lid 3 that is to be secured by means of closure clips 4 on the filter housing 2. The longitudinal axis of the fluid filter is identified by reference numeral 5. The insertion direction of the filter element 6 with the open lid 3 into the interior of the filter housing 2 is identified by reference numeral 18.

In the area of the housing bottom 9 opposite the lid 3 the filter housing 2 tapers. At this side of the filter housing in the housing interior a secondary filter element 10 is positioned that is arranged at the end face of the inserted filter element 6 and that separates the unfiltered side from the filtered side in the flow-tight way. In order to ensure proper seating of the filter element 10 in the interior of the filter housing 2 in the mounted position, the mounting aid elements 11 and 12 are provided on the inner wall of the filter housing 2 and on the filter element 10 and are embodied to match one another and engage one another in the mounted position. The mounting aid element 11 at the housing is embodied as a socket that extends from the bottom 9 of the filter housing in the axial direction and is formed as a unitary part of the wall of the housing. This socket 11 is positioned at a minimal radial spacing relative to the radially father outwardly positioned inner wall of the filter housing 2.

The mounting aid element 12 at the sealing side is configured as a recess in the filter element 10 into which the socket 11 of the filter housing 2 projects. The recess 12 is embodied to be closed at the bottom 13 so that it is ensured that in case of a wrong insertion of the filter element 10, i.e., with the bottom 13 leading, the socket 11 cannot project into the recess 12 but instead is resting immediately against the bottom 13 so that the axial end position of the filter element 10 is not reached and therefore the lid 3 also cannot be closed.

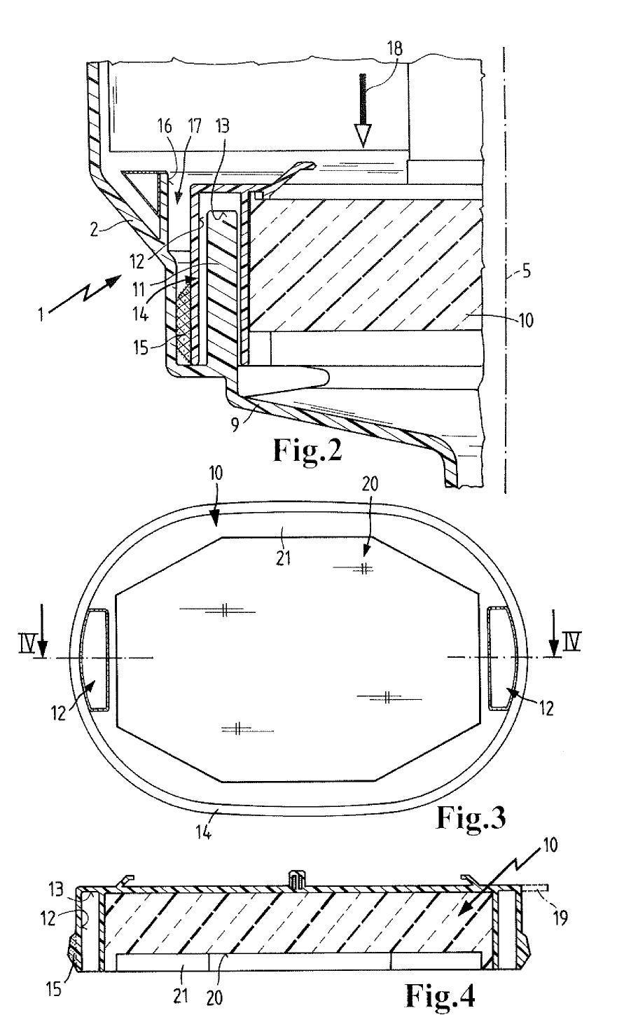

As shown in the detail illustration according to FIG. 2, at the radially outwardly positioned side of the outer filter wall 14 that radially outwardly delimits the recess 12 a sealing bead 15 is arranged that projects into the intermediate space 17 that is formed between the socket 11 at the housing and the housing wall. The sealing bead 15 extends radially outwardly and ensures a safe sealing action between the filter element 10 and the inner housing wall of the filter housing 2.

Moreover, FIG. 2 also shows that a centering wall section 16 is provided at the housing, which wall section extends in axial direction and is a unitary part of the housing wall but, relative to the latter, is slightly radially inwardly displaced. Viewed in the insertion direction 18 of the filter element 10 the centering wall section 16 is positioned axially in front of the socket 11 and, moreover, is radially outwardly displaced relative to it so that between the socket 11 and the centering wall section 16 an intermediate space 17 is formed. The centering wall section 16 has the task to force the filter element 10 that is to be axially inserted in the insertion direction 18 into the desired correct centering position relative to the radial direction. It can be expedient to provide the centering wall section 16 with a minimal slant so that the free end face of the centering wall section 16 is radially outwardly oriented whereby the centering wall section 16 is provided with the shape of a centering ramp and the insertion of the filter element 10 is facilitated.

In FIGS. 3 and 4, only the filter element 10 is shown. The filter element 10 is embodied as an elliptical disk wherein diametrically opposed two recesses 12 are provided in the narrow sides of the filter element 10. The filter element 10 has a sealing side 20 that is framed by a circumferentially extending axially projecting sealing rim 21.

According to FIG. 4, an additional radially projecting blocking section 19 is arranged optionally on the filter element 10 and is formed unitarily with the frame of the filter element 10 and is located axially at the side opposite the sealing side 20. In case of an accidental backward insertion of the filter element 10 into the housing interior, this blocking section 19 contacts either the tapering inner housing wall or another wall part of the housing, for example, the centering wall section 16 (FIG. 2). In this way, a further axial insertion into the final mounting position of the filter element 10 is blocked. Optionally, this blocking section 19 can be provided additionally on the filter element 10.

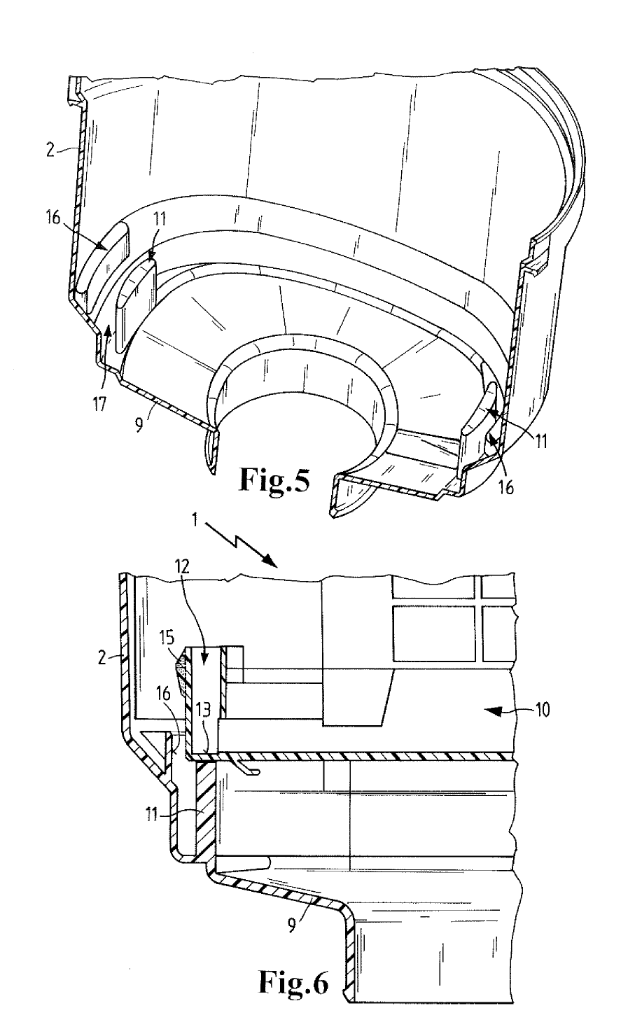

In FIG. 5, the housing interior of the filter housing 2 is shown in perspective illustration. Shown are the diametrically opposed sockets 11 that extend axially upwardly from the bottom 9 of the filter housing and are displaced slightly radially inwardly so that the intermediate space 17 between socket 11 and inner housing wall is formed. Also shown are the centering wall sections 16 that are arranged immediately adjacent to the sockets 11. Each socket 11 has correlated therewith a centering wall section 16. The socket 11 as well as the centering wall section 16 each have an extension in the circumferential direction of the filter housing 2.

In FIG. 6 a filter element 10 is shown in the backward position. In this backward position the socket 11 at the housing contacts the bottom 13 of the recess 12 in the filter element 10 so that a complete axial insertion of filter element 10 into the final mounting position is prevented.

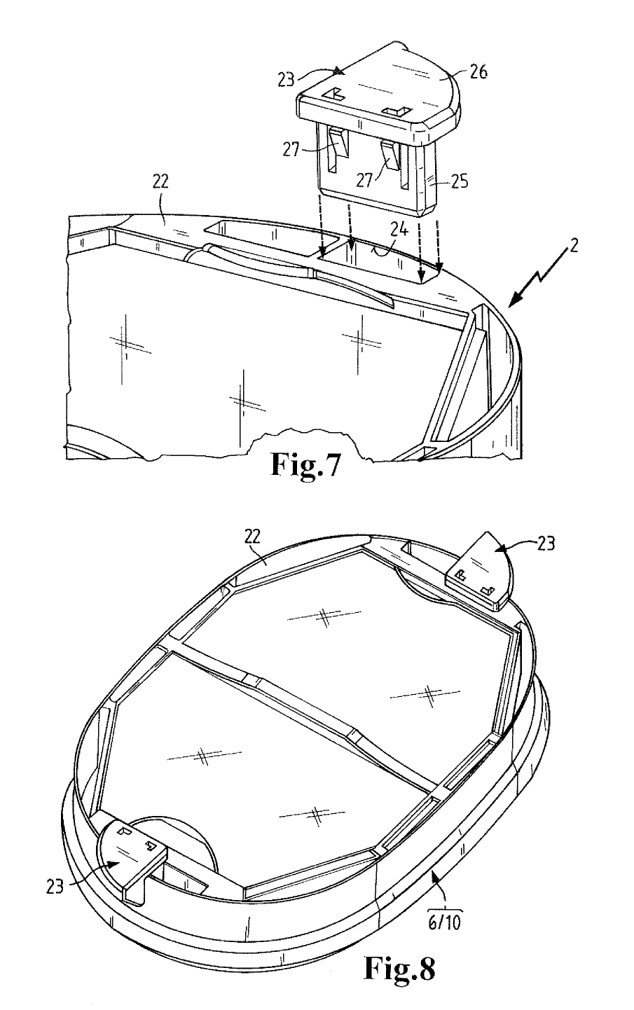

In FIG. 7 a frame 22 is illustrated that is connected to a component to be inserted into the housing 2 of the fluid filter 1. In order to ensure that this component is inserted correctly into the housing, a blocking part 23 is provided that is connected to the frame 22 and projects past the wall surface of the frame as well as of the component framed by the frame in the axial direction and in the radial direction. In this way it is ensured that the frame 22 inclusive the component that is connected to the frame can be inserted only in the prescribed way into the housing of the fluid filter.

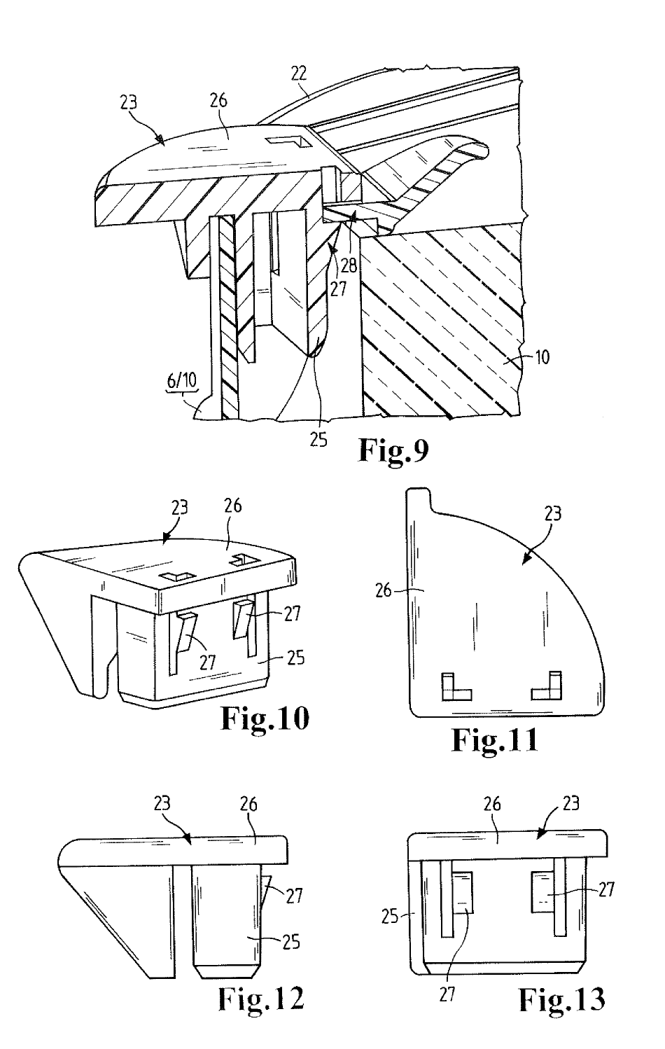

In the radially outwardly positioned area on the frame 22 a recess 24 is provided into which a socket 25 of the blocking part 23 can be axially inserted. The socket 25 is connected to a head 26 of larger circumferential contour that is of a circular segment shape and extends in particular across an angular segment of 90 degrees. The head 26 has a greater cross-sectional surface area than the socket 25 and projects, as shown in particular in FIGS. 8 and 9, past the radial outer side of the frame 22. FIG. 8 also shows that a total of two blocking parts 23 are arranged diametrically opposite one another on the frame 22. The blocking parts 23 are located at the narrow sides of the approximately oval frame 22 that is comprised of plastic material.

The frame 22 frames the filter element 10; the blocking parts 23 form the mounting aid elements in order to insert the frame 22 inclusive the filter element 10 in the correct predetermined way into the housing of the fluid filter and in order to prevent accidental wrong insertion. It is however also possible to provide the frame 22, including the blocking parts 23, on the filter element that is inserted into the housing. This embodiment can be realized independent of the embodiment of the filter element 10 with the mounting aid element.

As shown in FIGS. 7 and 9 in connection with individual illustrations of the blocking part 23 according to FIGS. 10 to 13, on the socket 25 of the blocking part 23 two parallel locking projections 27 extending in the axial direction of the socket are arranged that delimit a locking receptacle that is located immediately below the head 26. A leg of a locking member 28 (FIG. 9), which locking member is connected to the frame 22 and in particular is formed as a unitary part thereof, projects into the locking receptacle in the mounted position of the blocking part 23 on the frame 22. In this way, a locking action is provided in the inserted position of the blocking part 23 within the recess 24.

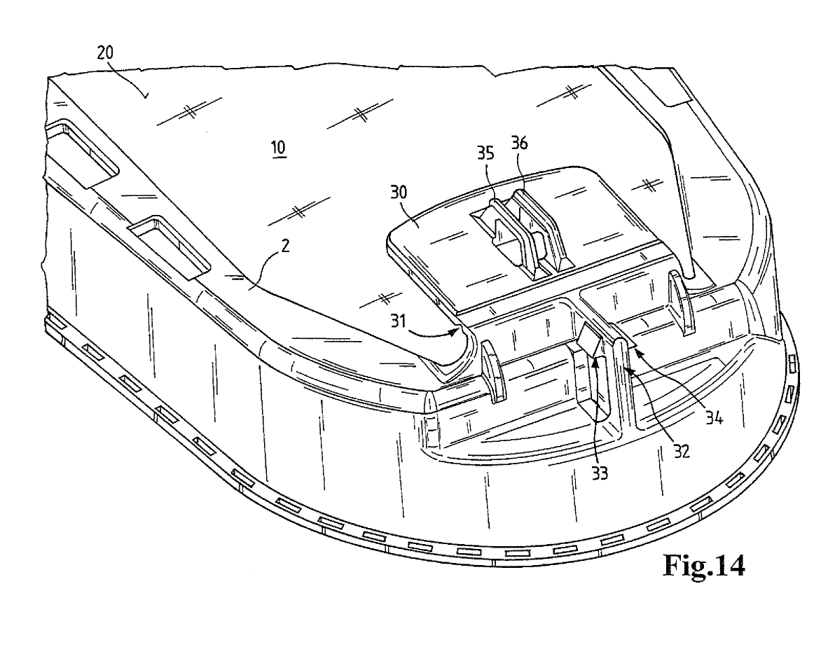

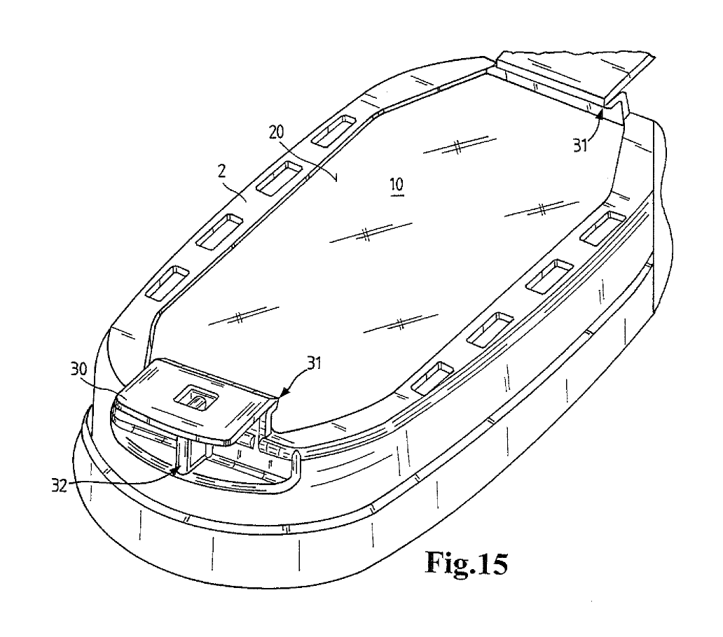

FIG. 14 shows the filter housing 2 with a blocking segment in an alternative embodiment. The blocking segment 30 is provided with a filter hinge 31. After foaming the frame and completing the entire filter element, the blocking segment is folded over in the direction of the locking web 32. The snap-on webs 35, 36 lock on the locking noses 33, 34 and form a non-releasable fixation of the blocking segment, as illustrated in FIG. 15. In this way, an anti-rotation device is formed that ensures that the filter element in principle can be attached only in the correct mounting position on the filter housing.

1. Fluid filter, comprising a filter element (10) that is insertable into a filter housing (2), characterized in that the filter element (10) comprises at least one mounting aid element (12) that is correlated with a corresponding mounting aid element (11) on the housing in such a way that the mounting aid element (11) on the housing and the mounting aid element (12) on the filter engage one another in the mounted position.

2. Fluid filter according to claim 1, characterized in that the mounting aid elements on the housing (2) and on the filter element (10) are formed as projection (11) and corresponding recess (12).

3. Fluid filter according to claim 2, characterized in that the recess (12) is provided in the filter element (10).

4. Fluid filter according to claim 3, characterized in that the bottom (13) of the recess (12) is closed off.

5. Fluid filter according to claim 4, characterized in that the projection is formed as a socket (11) in the housing interior which socket is arranged at a radial spacing to the an inner wall of the housing (2).

6. Fluid filter according to claim 1, characterized in that the mounting aid elements (11, 12) are brought into an engaged position in axial insertion direction of the filter element (6, 10).

7. Fluid filter according to claim 6, characterized in that at least two corresponding mounting aid elements (11, 12) are distributed about the circumference.

8. Fluid filter according to claim 1, characterized in that on the filter element (10) a radially projecting blocking section (19) is arranged.

9. Fluid filter according to claim 1, characterized in that an interor of the housing has a tapering cross-section.

10. Fluid filter according to claim 1, characterized in that on the inner wall of the housing (2) a centering wall section (16) is arranged that centers the filter element (10) upon axial insertion in the mounted position.

11. Fluid filter according to claim 10, characterized in that the centering wall section (16) is embodied as a ramp and is positioned at an angle relative to the insertion direction of the filter element (10).

12. Fluid filter according to claim 1, characterized in that the filter element (10) is disk-shaped.

13. Fluid filter according to claim 1, characterized in that the mounting aid element is a separately embodied blocking part (23) that is arranged on the filter element (10).

14. Fluid filter according to claim 13, characterized in that the blocking part (23) is insertable into a recess (24) of the filter element.

15. Fluid filter according to claim 13, characterized in that the filter element (10) is framed by a frame (22) and the blocking part (23) is arranged on the frame (22).

16. Fluid filter according to claim 13, characterized in that the blocking part (23) projects radially and axially past the wall surface of the filter element (10).

17. Fluid filter according to claim 1, characterized in that a blocking segment (30) is provided on the filter housing (2) and connected to the filter housing by a film hinge (31), wherein the blocking segment can be folded over and can be locked at a locking web (32), wherein the locking web comprises in particular two locking noses (33, 34) that interact with snap-on webs (35, 36) of the blocking segment (30).

18. A fluid filter, comprising:
a filter housing having an interior;
at least one projection arranged in said interior of said housing;
a filter element insertable in an axial direction in said interior into a mounted position, said filter element including
at least one recess arranged on circumferential portions of said filter element, said recesses and projections aligned and configured to be engageable when said filter element is in said mounted position;
wherein said recesses and projections are engaged in said axial direction; and
at least one centering wall section arranged in said interior, said centering wall sections configured and positioned to glideably guide said filter element into said mounted position.

19. The fluid filter according to claim 18, further comprising:
at least one blocking segment provided on said filter housing and connected to said filter housing by a foldable film hinge, said blocking segment including
at least one snap-on web;
at least one locking web secured to said filter housing, said locking web including
two locking noses lockably engageable with said snap on webs when said blocking segment is foldably rotated about said film hinge into position with said snap-on webs confronting said locking webs.
